(19) United States
(12) Patent Application Publication
(10) Pub. No.: US 2008/0026351 A1
(43) Pub. Date: Jan. 31, 2008

(54) Sports training apparatus

(76) Inventor: Eric William Thompson, Detroit, MI (US)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 11/497,163

(22) Filed: Jul. 31, 2006

(51) Int. Cl. A63B 69/00; G09B 19/00; G09B 9/00

(52) U.S. Cl. 434/251

(57) ABSTRACT

The apparatus for sports training includes a vertical bar attached to the front of a vest or other garment. The bar is attached to the vest by brackets, which may be resilient and may include a releasable mechanism. The vest is configured to be worn so that the bar has a vertical orientation in front of the user. The vertical bar may be covered with foam padding or other material less rigid than the bar itself. The bottom portion of the vertical bar may be generally straight and oriented substantially parallel to the user's torso. The top portion may be curved to extend away from the user. When used to train a football player, the apparatus encourages a player to catch a football with the player's hands as opposed to trapping the football against the player's body.

### FIELD OF THE INVENTION

The invention relates to apparatus and methods for sports training, and more particularly to apparatus and methods for training a user to keep the user's hands in front of the user's body.

### BACKGROUND OF THE INVENTION

For many players, poor positioning of the hands and arms can hinder performance and increase errors during play. Maintaining proper form and positioning is often a critical aspect of improving and maintaining a high level of performance in playing sports. For example, one of the fundamentals of catching a ball in many sports is to go to the ball rather than wait for the ball to come to you. In sports such as football and baseball, the mechanics of catching the ball may be improved if the player is able to consistently keep his or her hands in front of the body to catch the incoming ball.

A number of training devices are known, many of which are sport-specific. For example, there is a hockey goalie training aid which includes a vest to be worn on the torso of the goalie, and a horizontal bar attached to the front of the vest. The horizontal orientation of the bar in intended to inhibit the movement of the arms along side the goalie's body. The horizontal bar restricts the movement of the arms in order to keep the arms from moving behind or away from the goalie's body.

A number of basketball training devices are also known. One device includes a curved bar that pivots from one side of a player's waist. A sleeve that attaches to the elbow of the player slides along the curved bar to guide the player in throwing a basketball. Another device includes a first bar that extends upwardly at an angle from a player's waist to a point in front of the player's shoulder, a second bar that is attached at the upper end of the first bar and extends laterally to one side, and a guide bar attached to the second bar. The guide bar is for guiding movement of the player's elbow in preparing to throw a basketball. These devices are designed to inhibit the movement of the player's arms.

Golf swing training devices are also known. In one example, a guide rod extends diagonally across a player's chest. The rod is angled to guide the hands and arms upward and rightward to the proper location during the back swing. This training device is specifically designed to guide the movement of the golfer's hands in the back swing to correct the golfer's swing.

A need exits for a lightweight athletic training device that helps keep a player's hands in front of his or her body. A need also exists to train players without significantly restricting movement of other parts of the body. A need also exists to avoid or minimize the risk of injury to the player or other he or she may come into contact with in general training settings.

### SUMMARY OF THE INVENTION

Briefly and in general terms, the present invention is directed to an apparatus for training a user to keep the user's hands in front of the user's body without substantially impeding movement of the user's hands along side the user's body. The apparatus includes a garment configured to be worn by the user; a bracket extending outwardly away from the front of the garment; and a vertical bar connected to the bracket. The vertical bar has a generally vertical orientation in front of the user wearing the garment. The upper end of the vertical bar may curve away from the user wearing the garment. Preferably, the vertical bar is sized and dimensioned so as to not substantially interfere with the user's vision when the user is wearing the garment. The vertical bar is also sized and dimensioned to require the user to utilize his or her hands to catch a ball in front of the user, without substantially impeding movement of the user's arms along side the user's body.

The bracket may be sufficiently flexible to allow the vertical bar to be moved from a normal position to prevent injury, and sufficiently resilient to allow the vertical bar to return to the normal position. The bracket may also have a hinged connection with the garment. In addition or alternatively, the bracket may includes a releasable mechanism such as a breakaway connection associated with the vertical bar and/or the garment. The apparatus may also include a second bracket extending outwardly away from the front of the garment, wherein the two brackets form two points of a generally vertical line along the garment.

The apparatus trains the user wearing the garment to catch a ball away from the user's torso rather than against the user's torso. A method of training a user to keep the user's hands in front of the user's body when playing a sport, such as football, includes the steps of placing a training garment on a user, wherein the vertical bar is connected to bracket extending from the front of the garment such that the vertical bar will have a generally vertical orientation in front of the user wearing the garment; and catching a ball away from the user rather than against the user's body without substantially impeding movement of the user's arms along side the user's body.

The features and advantages of the invention will be more readily understood from the following detailed description which should be read in conjunction with the accompanying drawings.

### BRIEF DESCRIPTION OF THE DRAWINGS

FIG. 1 is a perspective view of a sports training apparatus showing a garment configured to be worn by a user of the apparatus, a bracket connected to the garment, and a vertical bar connected to the bracket, the vertical bar disposed generally at the center of the garment and extending outwardly away from the front of the garment;

FIG. 2 is a side view of the sports training apparatus of FIG. 1 being worn by the user showing straps connecting the front and back of the garment and the vertical bar having an upper end extending away from the user; and

FIG. 3 is front view of the sports training apparatus of FIG. 1 being worn by the user showing the vertical bar disposed between the user's shoulders and at the center of the user's torso.

### DETAILED DESCRIPTION OF THE PREFERRED EMBODIMENTS

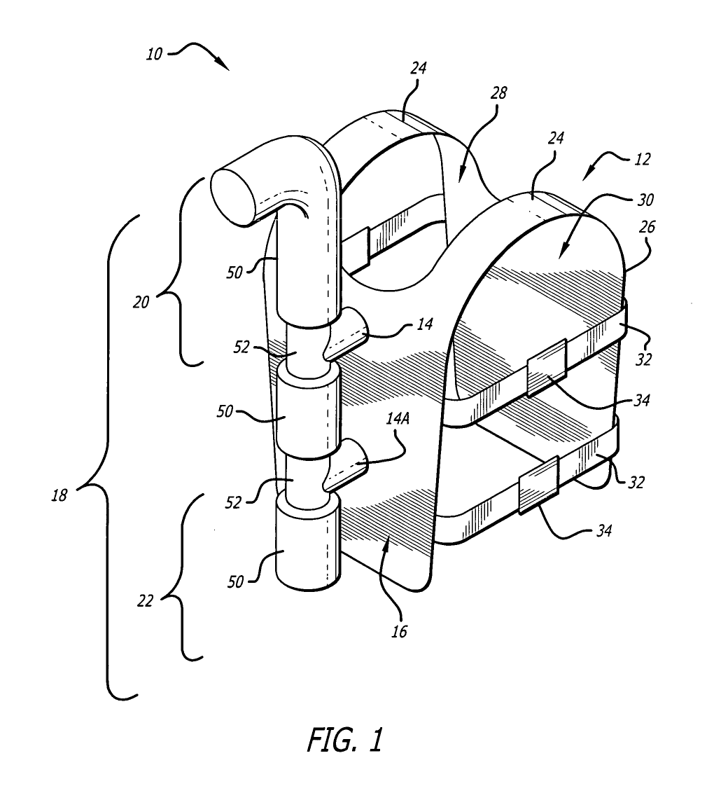

Referring now in more detail to the exemplary drawings for purposes of illustrating embodiments of the invention, wherein like reference numerals designate corresponding or like elements among the several views, there is shown in FIG. 1, a sports training apparatus 10 for training a user to catch a ball in front of the user rather than against the user's torso and for training a user to keep he user's hands at a distance in front of the user's body without substantially impeding movement of the user's hands along side the user's body. The apparatus 10 comprises a garment 12, a bracket 14 extending outwardly from the front 16 of the garment, and an elongate, vertical bar 18 connected to the bracket in a generally vertical orientation. The vertical bar 18 has an upper end 20 and a lower end 22. In the illustrated embodiment, lower end 22 of the vertical bar 18 is generally straight, and the upper end 20 of the vertical bar 18 is curved so as to extend away from the front of the garment 12.

In the embodiments shown, the apparatus further comprises a second bracket 14a that extends outwardly from the front 16 of the garment 12. The two brackets 14, 14a may be considered to form two points of a generally vertical line along the front of the garment. For example, the front of the garment may include a groove or channel for accepting the brackets. The second bracket can provide increased stability in maintaining the orientation of the vertical bar relative to the garment. The brackets may be formed integrally with the garment, or may be attachable to the garment. The brackets may also be formed integrally with the vertical bar. It will be appreciated that more than two brackets may be employed to provide greater stability and durability. In another embodiment not shown, there is only one bracket 14 or 14a connecting the vertical bar to the garment.

Still referring to FIG. 1, the garment 12 is preferably in the form of a vest to be worn on the torso of the user. The garment may be formed of a combination of padding, fabrics, and materials of varying flexibility to allow the garment to be worn comfortably. The garment may include a rigid or semi-rigid portion at and around the two points formed by the brackets 14, 14a to provide stability to the brackets and to safely distribute the force of a potential impact to the vertical bar 18 during use of the apparatus 10.

The garment 12 comprises two shoulder portions 24 extending from the front 16 of the garment to the back 26 of the garment. The shoulder portions are configured to support the apparatus 10 on the shoulders of the user and to prevent the vertical bar from moving down the user's torso. The two shoulder portions define a top opening 28 sized to allow the head and neck of the user to fit through. The front and back of the garment define two side openings 30, with only one side opening being visible in FIG. 1. Each side opening 30 is sized to allow an arm of the user to fit through it. The garment further comprises four straps 32, two on each side opening. The straps connect the front and the back of the garment and help to keep the garment secured on the user. The straps may be elastic or inelastic. The straps preferably include buckles 34 which allow the straps to be selectively lengthened and shortened to accommodate users with larger and smaller chests, respectively.

It will be appreciated that the garment may be configured in other ways to provide a suitable means of securing the apparatus to users having a range of sizes and shapes. For example, in an alternative embodiment there are no straps and the lower portions of the front and back of the garment meet to form side portions. In this alternative embodiment, arm holes are formed between the side portions and the shoulder portions. In another alternative embodiment, straps extend around the back and/or neck of the user, and there is no substantial back portion to the garment.

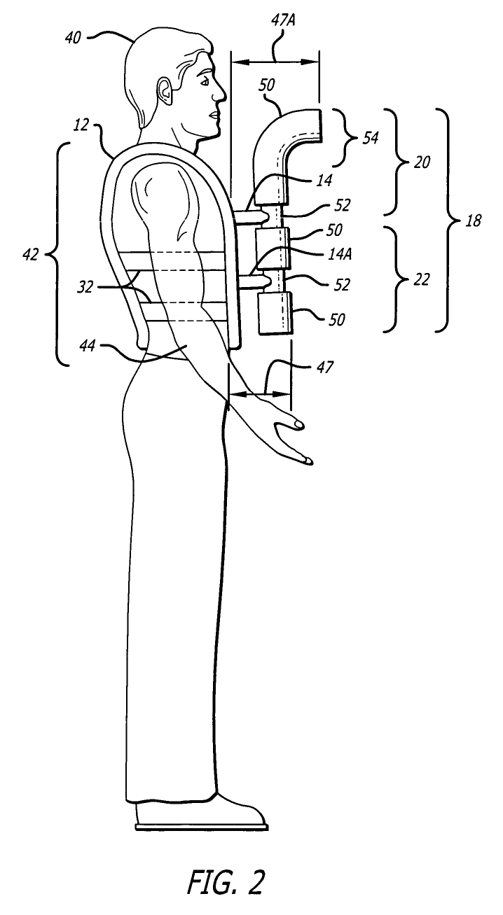

Referring now to FIG. 2, the apparatus 10 is shown being worn by a user 40. The garment 12 is secured to the torso 42 of the user by means of the straps 32 extending between the arms 44 and the torso of the user. The vertical bar 18 is connected by the brackets 14, 14a to the garment such that the vertical bar is generally parallel with the front of the torso 42. The upper end 20 of the vertical bar 18 curves away from the front 16 of the garment 12 and away from the user.

The vertical bar 18 is sized and dimensioned so as to not substantially interfere with the user's vision when the user is wearing the garment. In one embodiment, the upper end 20 of the vertical bar preferably extends vertically to a height between the user's eyes and chin. In another embodiment, the vertical bar extends vertically between the user's chin and shoulders to allow for a greater field of vision. In yet another embodiment, the vertical bar extends vertically to a height approximately level with the top of the user's shoulders.

It will be appreciated that it may be desirable for the size and dimension of the vertical bar 18 to be different for small children and large adults, since a vertical bar that extends to a level below the eyes of one user is likely to extend above the eyes of a shorter user. As such, the vertical bar is preferably dimensioned to approximate the vertical length of the intended user's torso. For example, the dimensions of the vertical bar may be adjustable, or the vertical bar may have a fixed, predetermined size to correspond to the size of the garment (e.g., small, medium, and large).

Still referring to FIG. 2, it will be appreciated that the vertical bar 18 is sized and dimensioned to require the user to utilize the user's hands to catch a ball in front of the user's torso. In particular, for the game of American football, the vertical bar 18 is disposed at a predetermined distance 47 away from the user's torso, thereby preventing the user from moving the user's hands close to the user's torso in order to encourage the user to use his or her hands to catch a ball in front of the user's body rather than “trap” the ball against the body. In order to catch the ball, the user's hands must be positioned beyond the predetermined distance of the vertical bar in front of the user's torso. Where the upper end 20 of the vertical bar 18 has a forward curvature, the user's hands must be at a greater distance 47a in front of the user's torso to catch an approaching ball at a level above the lower portion of the user's torso. The converse would apply if the lower end of the vertical bar had a forward curvature rather than the upper end.

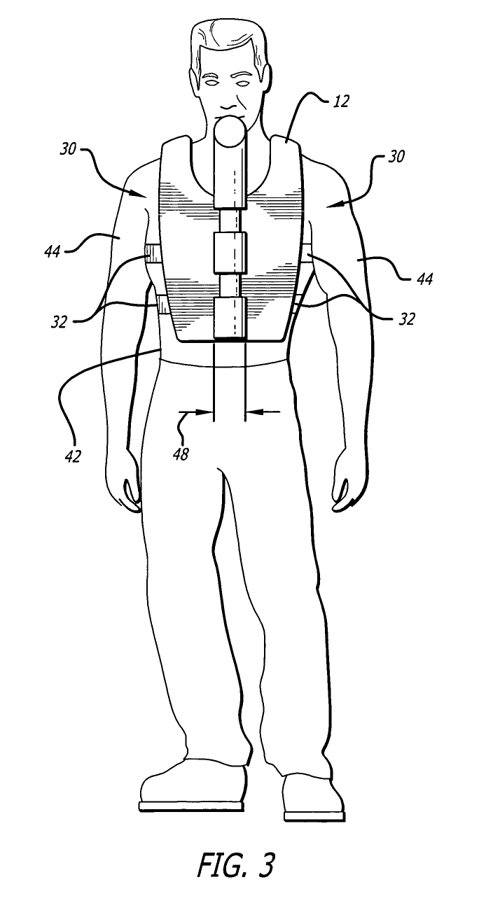

In FIG. 3 there is shown a front view of the apparatus 10 and the user 40 of FIG. 2. The vertical bar 18 is positioned approximately at the midpoint between the user's shoulders and is sized and dimensioned so as to be narrower in width than the width of the torso. In the illustrated embodiment, the vertical bar has a substantially uniform width 48 along its vertical length. In another alternative embodiment, the width of the vertical bar may vary along its vertical length so as to discourage the user from moving the user's hands toward selected areas close to the user's torso. In a preferred embodiment, no portion of the vertical bar, the garment 12, and the brackets 14, 14a extends into the area along side of the user's torso. In this way, the apparatus does not substantially impede movement of the user's arms or hands along side the user's body.

In FIGS. 1-3, the vertical bar 18 is shown in a normal position. In use, when the user 40 falls to the ground or collides with another person or a stationary structure, one or both brackets 14, 14a preferably have sufficient flexibility to allow the vertical bar to be moved from the normal position to prevent injury to the user and other persons, and sufficiently resiliency to allow the vertical bar to return to the normal position. Either or both brackets 14, 14a may include a biasing device, such as a metal or elastomeric spring member, that urges the vertical bar to automatically return to the normal position after being displaced. For example, a spring may be placed within an elastomeric tube. It will be appreciated that flexibility in one or both brackets would also increase the durability of the apparatus 10 in that parts of the apparatus would be less likely to fracture during use.

Either or both brackets 14, 14a may include a breakaway connection that separates when a predetermined amount of force is applied to the vertical bar. The breakaway connection may be associated with the garment so that the bracket breaks away or detaches from the garment in response to an impact force to the vertical bar having a predetermined magnitude and direction. Alternatively or in addition, the breakaway connection may be associated with the vertical bar so that the bracket detaches from the vertical bar in response to the impact to the vertical bar. The breakaway connection allows the vertical bar to move relative to the garment and the user. The breakaway connection may be configured to be reconnected after it has been separated. It will be appreciated that a breakaway connection on either or both brackets would prevent injury to the user and other persons and increase the durability of the apparatus 10.

Returning to FIGS. 1 and 2, the vertical bar 18 may include padding 50, such as foam padding or other pliable or deformable material, to absorb impact forces. In the embodiment shown, the vertical bar further comprises a core member 52 that is surrounded by the padding 50. The core member is coupled to the brackets 14, 14a and is preferably more rigid than the padding. The core member extends through the upper and lower ends 20, 22 of the vertical bar. In some embodiments, the core member does not extend through the curved portion 54 of the upper end 20 thereby allowing the curved portion to be more flexible than remaining portions of the vertical bar. It will be appreciated that the vertical bar may be constructed from a material having the desired combination of rigidity and pliability, and may not require separate padding. It will be appreciated that the vertical bar may be formed integrally with the brackets.

A method of training a user to keep the user's hands in front of the user's body when playing a sport, such as American football, will now be described. Although the method will be described in connection with terms associated with the sports training apparatus 10, it will be appreciated that another apparatus in accordance with the present invention may be used to implement the method. One step of the method involves placing a training garment on the torso of the user. Extending from the training garment is a bracket to which a vertical bar is connected so that the vertical bar has a generally vertical orientation generally parallel with the front of the torso of the user wearing the training garment. Another step involves catching a ball away from the user's torso, rather than trapping the ball against the user's torso. Preferably, the training garment, the bracket, and the vertical bar do not substantially impede movement of the user's hands and arms along side the user's body. Catching the ball away from the user's torso includes the user moving the user's hands at a distance in front of the user's torso, the distance being greater than a predetermined distance between the vertical bar and the training garment.

While several particular forms of the invention have been illustrated and described, it will also be apparent that various modifications can be made without departing from the scope of the invention. For example, the apparatus may be used to train athletes in different sports, such as volleyball, where it would be beneficial for the athlete to keep his or her hands in front of the body. It is also contemplated that various combinations or subcombinations of the specific features and aspects of the disclosed embodiments can be combined with or substituted for one another in order to form varying modes of the invention. Accordingly, it is not intended that the invention be limited, except as by the appended claims.

1. An apparatus for training a user to keep the user's hands in front of the user's body without substantially impeding movement of the user's hands along side the user's body, comprising:
a garment configured to be worn by the user;
a bracket extending outwardly away from the front of the garment;
a vertical bar connected to the bracket such that the vertical bar will have a generally vertical orientation in front of the user wearing the garment.

2. The apparatus of claim 1, wherein the vertical bar has an upper end and a lower end, and the upper end of the vertical bar curves away from the user wearing the garment.

3. The apparatus of claim 1, wherein the vertical bar is sized and dimensioned so as to not substantially interfere with the user's vision when the user is wearing the garment.

4. The apparatus of claim 1, wherein the garment is sized to be worn by the user having a general size and shape, and the vertical bar is dimensioned to approximate the length of the user's torso.

5. The apparatus of claim 1, wherein the vertical bar is sized and dimensioned to require the user to utilize the user's hands to catch a ball in front of the user's body.

6. The apparatus of claim 1, wherein the vertical bar is sized and dimensioned to require the user to utilize the user's hands to catch a ball in front of the user's body without substantially impeding movement of the user's arms along side the user's body.

7. The apparatus of claim 1, wherein the bracket is sufficiently flexible to allow the vertical bar to be moved from a normal position, and sufficiently resilient to allow the vertical bar to return to the normal position.

8. The apparatus of claim 1, wherein the bracket includes a breakaway connection associated with the vertical bar.

9. The apparatus of claim 1, wherein the bracket includes a breakaway connection associated with the garment.

10. The apparatus of claim 1, further comprising a second bracket extending outwardly away from the front of the garment, wherein the two brackets form two points of a generally vertical line along the garment.

11. An apparatus comprising:
a garment configured to be worn by a user;
means for training the user wearing the garment to catch a ball away from the user's torso rather than against the user's torso;
means for connecting the means for training to the garment.

12. The apparatus of claim 11, wherein the means for training does not substantially interfere with the user's vision when the user is wearing the garment.

13. The apparatus of claim 11, wherein the means for training does not substantially impede movement of the user's arm along side the user's body.

14. The apparatus of claim 11, wherein the means for training includes a vertical bar adapted to have a generally vertical orientation generally parallel with and in front of the torso of the user wearing the garment.

15. The apparatus of claim 14, wherein the vertical bar has an upper end and a lower end, and the upper end of the vertical bar curves away from the user wearing the garment.

16. The apparatus of claim 11, wherein the means for connecting includes a bracket sufficiently flexible to allow the means for training to be moved from a normal position, and sufficiently resilient to allow the means for training to return to the normal position.

17. The apparatus of claim 16, wherein the bracket includes a breakaway connection associated with the garment.

18. The apparatus of claim 11, wherein the means for connecting includes at least two brackets extending outwardly away from the front of the garment, wherein the at least two brackets form two points of a generally vertical line along the garment.

19. A method of training a user to keep the user's hands in front of the user's body when playing a sport, comprising the steps of:
placing a training garment on the torso of the user, wherein a vertical bar is connected to bracket extending from the front of the garment such that the vertical bar will have a generally vertical orientation generally parallel with and in front of the torso of the user wearing the garment;
catching a ball away from the user's torso rather than against the user's torso without substantially impeding movement of the user's arms along side the user's torso.

20. The method of claim 19, wherein the sport is football.
